(19) United States
(12) Patent Application Publication
(10) Pub. No.: US 2015/0019522 A1
(43) Pub. Date: Jan. 15, 2015

(54) METHOD FOR OPERATING APPLICATION AND ELECTRONIC DEVICE THEREOF

(71) Applicant: Samsung Electronics Co., Ltd., Gyeonggi-do (KR)

(72) Inventors: Seung-Nyun Kim, Incheon (KR); Myung-Geun Koh, Gyeonggi-do (KR); Geon-Soo Kim, Gyeonggi-do (KR)

(21) Appl. No.: 14/329,679

(22) Filed: Jul. 11, 2014

(30) Foreign Application Priority Data
Jul. 12, 2013 (KR) 10-2013-0082496

(51) Int. Cl. G06F 17/30; G06F 3/0484; G06F 3/048; G06F 3/0488

(52) U.S. Cl. CPC G06F 17/30979; G06F 3/04886; G06F 3/04847; G06F 3/048
USPC 707/706

(57) ABSTRACT

A method in an electronic device comprises displaying an Input Method Editor (IME) on a window on the electronic device, receiving data that is entered through the IME, searching for at least one content including a text message, the content being related to the text, and displaying a search result on the window. An electronic device comprises a touch screen configured to receive a touch input, and at least one processor coupled with the touch screen, wherein the processor is configured to cause the touch screen to display an Input Method Editor (IME) in a first window, search for at least one content including a text message, the content being related to the text, and display a search result on the window.

### PRIORITY

The present application is related to and claims priority under 35 U.S.C. §119(a) to a Korean Patent Application filed in the Korean Intellectual Property Office on Jul. 12, 2013 and assigned Serial No. 10-2013-0082496, the contents of which are herein incorporated by reference.

### TECHNICAL FIELD

The disclosure relates to an electronic device. More particularly, the disclosure relates to a method for operating an application in an electronic device.

### BACKGROUND

In recent years, with the rapid growth of electronic industries and communication technologies, new services based on data, a voice, and a video are being developed quickly. The rapid growth of micro electronic technologies and computer software and hardware technologies became the basis of electronic devices for processing more complicated works, and could get the electronic devices to provide up to a range of solving a network limit and have more and more powerful functionality. Also, even at user sides, the demand for electronic devices, specifically, mobile terminals such as smart phones is urgent, and electronic devices having more and more powerful functionality and being more flexible are preferred.

Due to the development of communication technologies, these electronic devices are evolving into multimedia devices providing various multimedia services using data communication services as well as voice call services. To provide various multimedia services, the electronic device can install and run various applications. The aforementioned various applications installed in the electronic device bring about a trouble that a user should directly search and execute an application for a multimedia service that the user intends to use among the various applications installed in the electronic device. Accordingly, there is a need for a more efficient user interface capable of easily running an application that the user desires.

### SUMMARY

A method in an electronic device comprises displaying an Input Method Editor (IME) on a window on the electronic device, receiving data that is entered through the IME, searching for at least one content including a text message, the content being related to the text, and displaying a search result on the window.

In certain embodiments, the IME may be a virtual keypad

In certain embodiments, the window may be a dialing screen for a call.

In certain embodiments, if at least a portion of the input text is deleted, the IME may be re-displayed in the window.

In certain embodiments, the text may be some or all of at least one of a name, a phone number, an initial sound, an electronic-mail (e-mail) address, and an initial.

In certain embodiments, the at least one content may include user information of a user corresponding to the text.

In certain embodiments, the user information may include at least one of the name, the phone number, a photo, a birthday, an address, a location, and application information.

In certain embodiments, the application information may include an application entry icon of at least one of gallery, camera, Social Network Service (SNS), message, schedule, e-mail, and user based applications related to the user.

In certain embodiments, at least one content may be substitutively displayed in a region of at least a portion of the window.

An electronic device comprises a touch screen configured to receive a touch input, and at least one processor coupled with the touch screen, wherein the processor is configured to cause the touch screen to display an Input Method Editor (IME) in a window, search for at least one content including a text message, the content being related to the text, and display a search result on the window.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with; be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating a construction of an electronic device according to various embodiments of the disclosure;

FIGS. 2A to 2C illustrate a keyword input process using a dialing function of an electronic device according to embodiments of the disclosure;

FIG. 3 illustrates a screen configuration where a search result is shown in an electronic device according to embodiments of the disclosure;

FIGS. 4A and 4B illustrate an operation of executing an application on a search results according to various embodiments of the disclosure;

FIGS. 5A and 5B illustrate an operation of restoring to a search mode in a search completion state according to various embodiments of the disclosure;

FIGS. 6A and 6B are diagrams illustrating an operation of executing an application on a search result according to one exemplary embodiment of the disclosure;

FIGS. 7A and 7B illustrate an operation of executing an application on a search result according to embodiments of the disclosure;

FIGS. 8 and 9 illustrate a screen configuration of a search result according to various embodiments of the disclosure;

FIG. 10 is a flowchart illustrating an operation method of an electronic device according to various embodiments of the disclosure;

FIG. 11 is a flowchart illustrating an operation method of an electronic device according to exemplary embodiments of the disclosure;

FIG. 12 is a flowchart illustrating an operation method of an electronic device according to various embodiments of the disclosure;

FIG. 13 is a flowchart illustrating an operation method of an electronic device according to various embodiments of the disclosure; and

FIG. 14 is a flowchart illustrating an operation method of an electronic device according to various embodiments of the disclosure.

### DETAILED DESCRIPTION

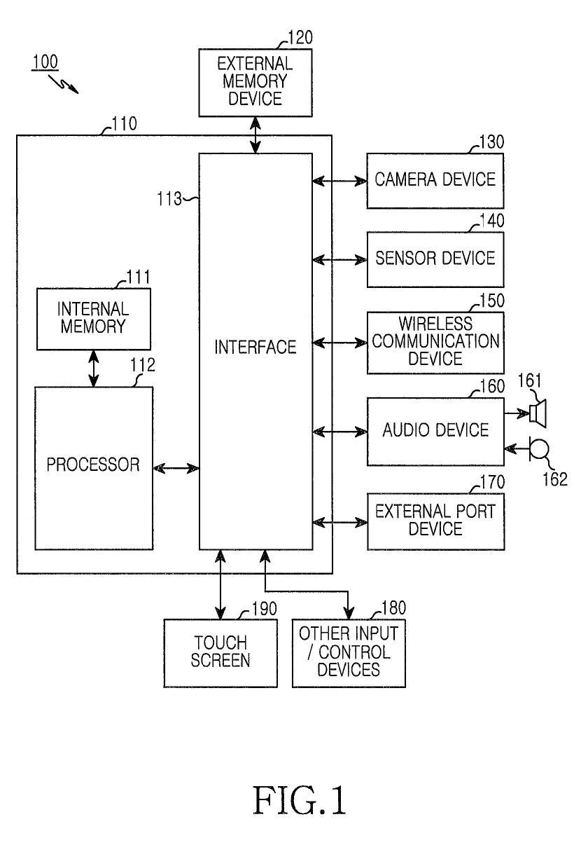

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronics devices. Preferred embodiments of the disclosure will be described herein below with reference to the accompanying drawings. In the following description, well-known functions or constructions are not described in detail since they would obscure the invention in unnecessary detail. And, terms described below, which are defined considering functions in the disclosure, can be different depending on user and operator's intention or practice. Therefore, the terms should be defined on the basis of the disclosure throughout this specification.

Terms including ordinal numbers such as 1st, 2nd, etc. can be used to describe various constituent elements, but the terms do not intend to limit the constituent elements. The terms are used only for the purpose of distinguishing one constituent element from other constituent elements. For instance, a 2nd constituent element can be named as a 1st constituent element without departing from the scope of the disclosure and, likewise, even the 1st constituent element can be named as the 2nd constituent element.

When it is mentioned that one constituent element is ‘connected’ or ‘accessed’ to another constituent element, it should be understood that one constituent element can be directly connected or accessed to another constituent element or the third constituent element can exist in between the two constituent elements. In contrast, when it is mentioned that one constituent element is ‘directly connected’ or ‘directly accessed’ to another constituent element, it should be understood that the third constituent element does not exist in between the two constituent elements.

The terms used in the disclosure are used for just describing specific exemplary embodiments, and do not intend to limit the scope and spirit of the disclosure. The expression of singular number includes the expression of plural number unless clearly meaning otherwise in a context. In the disclosure, it should be understood that terms of ‘comprise’, ‘include’, ‘have’, etc. are to indicate the existence of a feature, a numeral, a step, an operation, a constituent element, a part, or a combination thereof in the disclosure, and do not previously exclude a possibility of existence or supplement of one or more other features, numerals, steps, operations, constituent elements, parts, or combinations thereof.

A method for operating an application and an electronic device thereof according to an exemplary embodiment of the disclosure are described below.

In describing various exemplary embodiments of the disclosure, an electronic device having a touch screen applicable as a display unit is illustrated and described, but this does not intend to limit the scope and spirit of the disclosure. For example, the electronic device is applicable as various devices including touch screens, that is, Personal Digital Assistants (PDAs), laptop computers, mobile phones, smart phones, netbooks, Mobile Internet Devices (MIDs), Ultra Mobile Personal Computers (UMPCs), tablet PCs, navigators, MPEG Audio Layer-3 (MP3) players and the like.

In the following description, an application includes a phonebook, a game, a short message service, a multimedia message service, a browser, an electronic mail (e-mail), an instant message, a wake-up call, MP3, schedule management, a camera, word processing, keyboard emulation, an address book, a touch list, a widget, Digital Right Management (DRM), voice recognition, voice replication, a position determining function, a location based service, and the like.

FIG. 1 is a block diagram illustrating a construction of an electronic device 100 according to various embodiments of the disclosure.

Referring to FIG. 1, the electronic device 100 can be a device such as a mobile phone, a media player, a tablet computer, a handheld computer, or a PDA. Also, the electronic device 100 can be any portable terminal including a device having a combination of two or more functions among these devices.

The electronic device 100 includes a host device 110, an external memory device 120, a camera device 130, a sensor device 140, a wireless communication device 150, an audio device 160, an external port device 170, a touch screen 190, and other input/control devices 180. The external memory device 120 and the external port device 170 can be constructed in plural.

The host device 110 can include an internal memory 111, one or more processors 112, and an interface 113. The internal memory 111, the one or more processors 112, and the interface 113 can be separate constituent elements or can be integrated in one or more integrated circuits.

The processor 112 can execute various software programs to perform various functions for the electronic device 100 and perform processing and control for voice communication, video communication, and data communication. Further to this general function, the processor 112 can execute software modules (i.e., instruction sets) stored in the internal memory 111 or the external memory device 120 to perform various functions corresponding to the software modules.

By interworking with the software modules stored in the internal memory 111 or the external memory device 120, the processor 112 can carry out methods of various exemplary embodiments of the disclosure. The processor 112 can control the electronic device 100 to provide various multimedia services using at least one software program. At this time, the processor 112 can execute at least one program stored in the memories 111 and 120 to provide a service corresponding to a corresponding program.

The processor 112 can update information of an application list that is provided from a counterpart electronic device connected through a wired, wireless or local area communication network. The processor 112 can control to update the application list such that the application list includes only information of an application executable in the electronic device 100 among applications included in the application list that is provided from the counterpart electronic device connected through the communication network, and display the updated application list on the touch screen 190.

According to various exemplary embodiments, the processor 112 can control to display an Input Method Editor (IME) on the touch screen 190. Also, the processor 112 can control to display a text being input by the IME, and display text-related contents stored in the electronic device 100 or contents received from a server, on the touch screen 190.

The processor 112 can include one or more data processors, image processors, or COder/DECoders (CODECS). Further, the electronic device 100 can separately construct the data processor, the image processor, or the CODEC.

The interface 113 can connect the host device 110 with various devices of the electronic device 100.

The camera device 130 can perform a camera function of photo and video clip recording and the like. The camera device 130 can include a Charged Coupled Device (CCD), a Complementary Metal-Oxide Semiconductor (CMOS), or the like. The camera device 130 can adjust a change of a hardware construction, for example, lens movement, the number of irises and the like according to a camera program executed by the processor 112.

Various constituent elements of the electronic device 100 can be coupled with one another through one or more communication buses (not denoted by reference numerals) or electrical connection means (not denoted by reference numerals).

The sensor device 140 can include a motion sensor, a hall sensor, an illumination sensor, an image sensor, a variable resistance sensor, and the like. The motion sensor can sense a motion of the electronic device 100, and can sense ambient light. The electronic device 100 can include various sensors besides the aforementioned sensors.

The wireless communication device 150 performs wireless communication, and can include a radio frequency transceiver and/or an optical (e.g., infrared) transceiver. According to a communication network, the wireless communication device 150 can be designed to operate through at least one or more of a Global System for Mobile Communication (GSM) network, an Enhanced Data GSM Environment (EDGE) network, a Code Division Multiple Access (CDMA) network, a Wireless-Code Division Multiple Access (W-CDMA) network, a Long Term Evolution (LTE) network, an Orthogonal Frequency Division Multiple Access (OFDMA) network, a Wireless Fidelity (Wi-Fi) network, a Wireless interoperability for Microwave Access (WiMAX) network, and a Bluetooth network.

The audio device 160 can be connected to the speaker 161 and the microphone 162 and take charge of audio input and output of voice recognition, voice replication, digital recording, and call functions or the like. The audio device 160 can receive a data signal from the host device 110, convert the received data signal into an electrical signal, and output the converted electrical signal through the speaker 161.

The speaker 161 can convert electrical signals into audible frequency band signals and output the audible frequency band signals. The speaker 161 can be arranged in rear of the electronic device 100. The speaker 161 can include a flexible film speaker attaching at least one piezoelectric to one vibration film.

The microphone 162 can convert sound waves forwarded from human or other sound sources into electrical signals. Also, the microphone 162 forwards the converted electrical signals to the audio device 160. The audio device 160 can receive the electrical signals from the microphone 162, convert the received electrical signals into audio data signals, and transmit the converted audio data signals to the host device 110. The audio device 160 can include an earphone, headphone or headset which is detachable from the electronic device 100.

The external port device 170 can directly connect the electronic device 100 to other electronic devices or indirectly connect the electronic device 100 to other electronic devices over a network (e.g., the Internet, an intranet, a wireless Local Area Network (LAN) and the like).

The touch screen 190 provides an input output interface between the electronic device 100 and a user. For example, the touch screen 190 can apply a touch sensing technology, and forward a user's touch input to the host device 110, and show visual information, a text, a graphic, a video or the like provided from the host device 110, to a user.

According to various exemplary embodiments, the touch screen 190 can display an IME. This IME can be implemented as a virtual keypad. But, the IME is not limited to this, and the IME can be implemented in various schemes such as a virtual pointer, a voice recognition scheme or the like.

The touch screen 190 can display status information of the electronic device 100, a character input by a user, a moving picture, a still picture and the like. The touch screen 190 can display information of an application driven by the processor 112.

The touch screen 190 can apply not only capacitive, resistive, infrared and surface acoustic wave technologies, but also any multi-touch sensing technology including other proximity sensor arrays or other elements. The touch screen 190 can apply at least one of a Liquid Crystal Display (LCD), an Organic Light Emitting Diode (OLED), an Active Matrix Organic Light Emitting Diode (AMOLED), a flexible display, and a three-dimensional display.

The other input/control devices 180 can provide input data generated by user's selection to the processor 112 through the interface 113. At this time, the other input/control devices 180 can include a keypad including at least one hardware button, a touch pad sensing touch information, and the like. The other input/control devices 180 can include an up/down button for volume control. Besides this, the other input/other devices 180 can include at least one of a push button, a locker button, a rocker switch, a thumb-wheel, a dial, a stick, and a pointer device such as a stylus, and the like that are given corresponding functions.

The external memory device 120 can include high-speed random access memories and/or non-volatile memories such as one or more magnetic disk storage devices, one or more optical storage devices and/or flash memories (for example, Not AND (NAND) memories, Not OR (NOR) memories). The external memory device 120 stores software. The software can include an Operating System (OS) module, a touch operation module, a communication module, a graphical module, a user interface module, a CODEC module, a camera module, and one or more application modules. The term of module can be expressed as a set of instructions, an instruction set, or a program.

The OS module can include an embedded operating system such as WINDOWS, LINUX, Darwin, RTXC, UNIX, OS X, or VxWorks, and can include various software constituent elements controlling general system operation. Control of the general system operation can include memory control and management, storage hardware (device) control and management, power control and management, and the like. The OS module can perform even a function of making smooth communication between various hardware (devices) and software constituent elements (modules).

The touch operation module can include not only a software constituent element for correcting a touch error recognized in a touch panel Integrated Circuit (IC) but also various routines for touch operation support according to the disclosure. According to various exemplary embodiments, the touch operation module can perform a support for the processor 112 to operate in response to an input of the IME displayed on the touch screen 190.

The touch operation module can include a routine of supporting to activate a touch panel, and a routine of collecting a hand touch event occurring by a finger and the like during a touch panel activation operation. Also, the touch operation module can include a routine of operating touch events with reference to a predetermined touch operation table.

The communication module can enable communication with a counterpart electronic device of a computer, a server, an electronic device and the like through the wireless communication device 150 or the external port device 170.

The graphical module can include various software constituent elements for providing and displaying a graphic on the touch screen 190. The term of graphic can include a text, a web page, an icon, a digital image, a video, an animation, and the like.

The user interface module can include various software constituent elements related to a user interface. According to various exemplary embodiments, the user interface module can include an instruction for displaying an IME on the touch screen 190. Also, the user interface module can include various instructions for displaying a text input by the IME and displaying various contents related to the input text.

Also, the user interface module can include information about how a state of a user interface is changed, whether the change of the state of the user interface is carried out in which condition, or the like.

The CODEC module can include a software constituent element related to encoding and decoding of a video file.

The camera module can include a software constituent element related to a camera, for enabling processes and functions related to the camera.

The application module can provide applications including a browser, an e-mail, a phonebook, a game, a short message service, a multimedia message service, an instant message, a wake-up call, MP3, schedule management, a camera, word processing, keyboard emulation, an address book, a touch list, a widget, DRM, voice recognition, voice replication, a position determining function, a location based service, and the like. To provide these various services, the application module can include related process and software constituent element.

The host device 100 can further include additional modules (instructions) besides the aforementioned modules. Various functions of the electronic device 100 according to various exemplary embodiments of the disclosure can include a hardware or software including one or more processing or Application Specific Integrated Circuits (ASICs).

Various exemplary embodiments described below have illustrated and described a process of inputting a keyword in a dialing screen for call and displaying contents corresponding to the keyword in an electronic device, but are not limited to this. For example, it should be noted that the electronic device can be embodied even in a state of executing various applications or in a basic setting screen state.

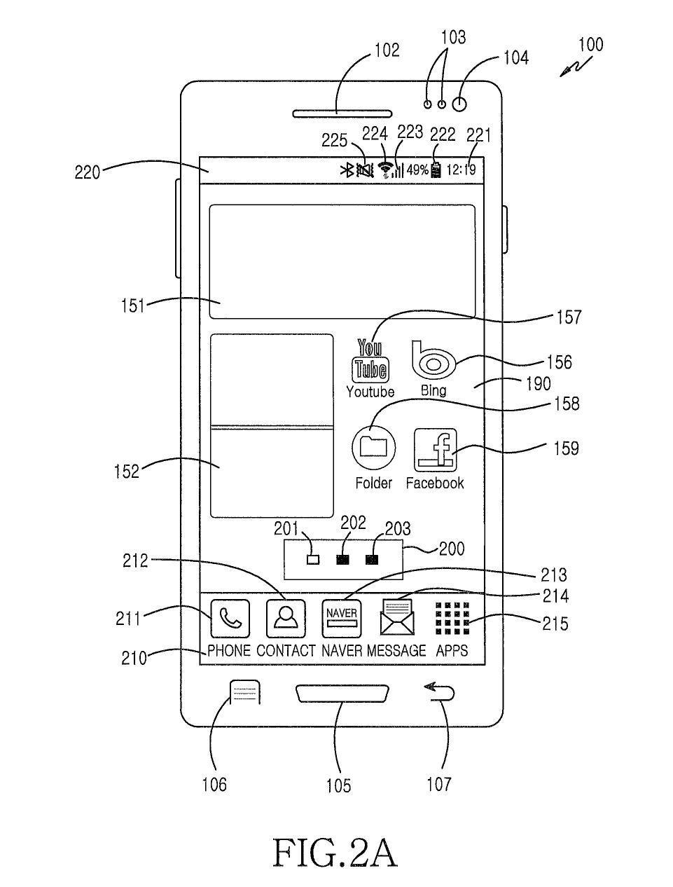

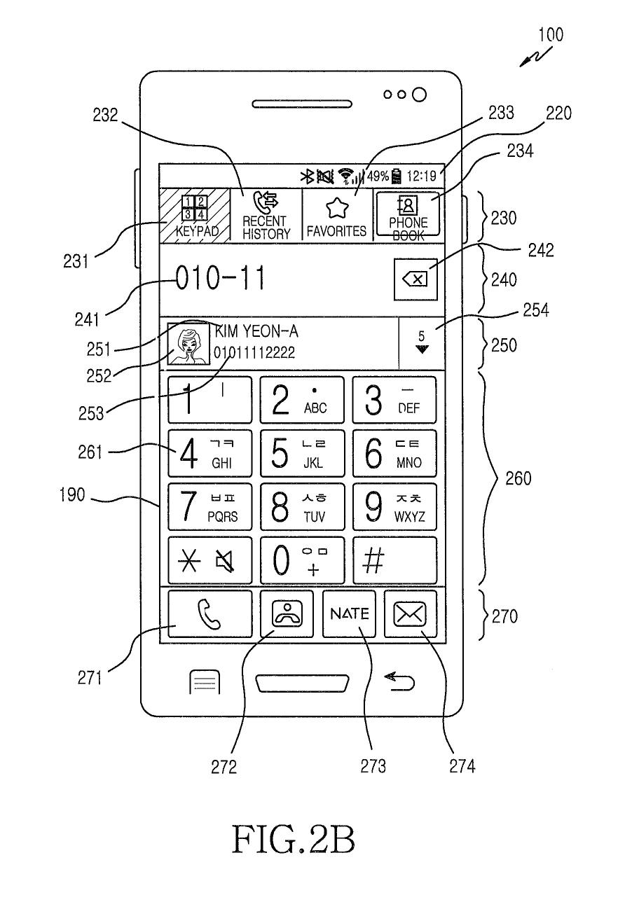

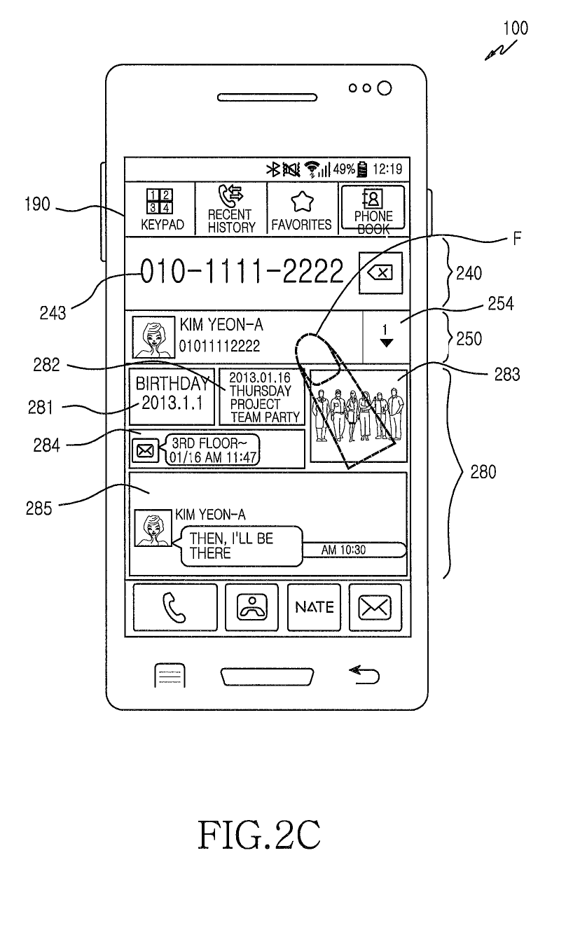

FIGS. 2A to 2C illustrate a keyword input process using a dialing function of the electronic device 100 according to embodiments of the disclosure.

Referring to FIG. 2A, the touch screen 190 can be arranged on one surface of the electronic device 100. A speaker 102, a plurality of sensors (e.g., an illumination sensor, a proximity sensor, and the like) 103, and a camera module 104 are arranged above the touch screen 190. A physical button (it is also called a ‘home button’) 105 is arranged below the touch screen 190. If the physical button 105 is pushed, the physical button 105 can perform a function of temporarily or fully changing into a basic setting screen in a currently executed function of the electronic device 100. The physical button 105 can be used as a call start button. Accordingly, it is desirable that the physical button 105 is a push button which is easy for user's handling.

This push button can be a key button installing a metal dome on a substrate included within the electronic device 100, and provides a click sense to a user. Also, a 1st touch padding button 106 for setting a program or function displayed on the touch screen 190 can be arranged at one side of the physical button 105, and a 2nd touch padding button 107 for canceling the program or function displayed on the touch screen 190 can be arranged at the other side of the physical button 105. But, this does not intend to limit the scope and spirit of the disclosure, and it does not matter that other known buttons are applied as the setting button 106 and the canceling button 107. In the drawings, these buttons 105, 106, and 107 are provided outside the touch screen 190, but these buttons 105, 106, and 107 can be displayed as some constituent elements of the touch screen 190 together.

According to one embodiment, the touch screen 190 can be composed of a basic screen displayed when the electronic device 100 is in a wake-up state. The touch screen 190 can arrange a plurality of objects 151, 152, 156, 157, 158, and 159 at predetermined intervals or in a specific region. The objects 151, 152, 156, 157, 158, and 159 can be set to change in location or region by a user. The objects 151, 152, 156, 157, 158, and 159 can be widget icons 151 and 152 and program display icons 156, 157, 158, and 159 according to user's setting. The objects 151, 152, 156, 157, 158, and 159 can further include shortcut icons executable by the user.

According to one exemplary embodiment, it is general that the plurality of objects 151, 152, 156, 157, 158, and 159 included in the electronic device 100 are constructed to have a number greatly exceeding a currently seen screen of the touch screen 190. Accordingly, the currently seen screen can be merely one page among a plurality of pages, and a great number of pages can be turned by a specific touch motion. This specific touch motion is a swipe touch or panning touch of a predetermined direction on a current page region. By the specific touch motion, the currently seen screen can be changed to a next page or previous page. Also, an indicator part 200 can be arranged in a predetermined region of the touch screen 190 such that a user can be aware of information about the entire page at a glance. For example, the indicator part 200 can include three indicators 201, 202, and 203 and accordingly, it can be appreciated that the entire page is composed of three pages and a current page is the first page.

According to various embodiments, a lower region of the touch screen 190 is provided as a fixed menu region 210. The fixed menu region 210 can house objects 211, 212, 213, 214, and 215 for basic functions of the electronic device 100. For example, a dialing icon 211, a contact icon 212, a message sending/receiving icon 214, an application selecting icon 215, and the like can be arranged in the fixed menu region 210. An Internet entry icon 213 widely used and the like can be additionally arranged according to user's setting.

According to one embodiment, a status bar 220 for informing a user of various status information of the electronic device 100 can be displayed in an upper region of the touch screen 190. The status bar 220 can include time 221, a battery level indicator 222, signal strength indicators 223 and 224 for wireless communication, an indicator 225 of notification information of an output of the electronic device 100, and the like.

Referring to FIG. 2B, the touch screen 190 can be constructed as a screen in which a call with a counterpart can be made. This screen can be a dialing screen. According to one exemplary embodiment, the touch screen 190 can arrange a plurality of objects 230, 240, 250, 260, and 270 at predetermined intervals or in a specific region. The objects 230, 240, 250, 260, and 270 can be set to change in location or region by a user. The objects 230, 240, 250, 260, and 270 can further include shortcut icons executable by the user.

According to one exemplary embodiment, a fixed menu region 230 can be arranged below the status bar 220 in the touch screen 190. The fixed menu region 230 can arrange a keypad icon 231, a recent history icon 232, a favorite icon 233, a phone book icon 234, and the like. According to various exemplary embodiments, the fixed menu region 230 can perform a role of the aforementioned indicator part 200, and the four icons 231, 232, 233, and 234 included in the fixed menu region 230 can perform roles of the aforementioned indicators 201, 202, and 203.

The fixed menu region 230 illustrates the four icons 231, 232, 233, and 234, so the fixed menu region 230 can be composed of four pages. By a swipe touch and panning touch of predetermined direction on a current page region, a current page displayed on the touch screen 190 can move to a recent history icon 232 page that is a next page. The keypad icon 231 can be highlighted and displayed at a different size from the other three icons 232, 233, and 234, to inform a user that the current page displayed on the touch screen 190 is a keypad icon 231 page. Undoubtedly, it is obvious that, when the touch screen 190 moves the current page and displays the recent history icon 232 page by a motion of touching the recent history icon 232, the recent history icon 232 of the fixed menu region 230 can be highlighted and displayed larger than the other icons 231, 233, and 234.

According to various embodiments, a lower region of the touch screen 190 is provided as an assistance menu region 270. The assistance menu region 270 can include objects 271, 272, 273, and 274 for basic functions of the electronic device 100. For example, a call icon 271, a video call icon 272, a message sending/receiving icon 274, and the like can be arranged in the assistance menu region 270. An Internet entry icon 273 widely used and the like can be additionally arranged according to user's setting.

The touch screen 190 can arrange objects 240, 250, and 260 for phone number input and search. According to one exemplary embodiment, an input display region 240 can be arranged below the fixed menu region 230 and input and display a keyword 241 including some or all of at least one of a phone number, an initial sound, an e-mail address, and an initial that are related to information stored in a memory of the electronic device 100. The input display region 240 can include a backspace key 242 for partially deleting the keyword 241 input and displayed.

According to one embodiment, a search list screen 250 can be arranged below the input display region 240 and display a search list corresponding to the input keyword 241. User information corresponding to the input keyword 241 can be displayed in the search list screen 250. The user information can include a user name 251, a user's photo 252, a user's phone number 253, a user's e-mail address, a user's birthday, a user's location, application information, or the like. An object list icon 254 can be displayed in the search list screen 250 to show the number of objects corresponding to the input keyword 241.

If a numeral ‘5’ is displayed in the object list icon 254, it can be appreciated that objects corresponding to the input keyword 241 are five in number. If the object list icon 254 is executed, user information about the five objects corresponding to the input keyword 241 can be displayed.

According to various embodiments, if a user selects the search list screen 250, user information displayed in the search list screen 250 can be input to the input display region 240. Though described later, as illustrated in FIG. 2C, a user's phone number 243 can be input to the search list screen 250. This state, i.e., a state of completing a search through the IME 260 or a state of selecting the search list screen 250 and completing the search can be defined as a “search completion mode”. A state up to before completing the search can be defined as a “search mode”.

According to one embodiment, the IME 260 capable of inputting the keyword 241 can be displayed below the search list screen 250. This IME 260 can be a virtual keypad, for example, can be a dial keypad. But, the ME 260 is not limited to this, and the IME 260 can be variously implemented like a virtual pointer, a voice input scheme and the like. The dial keypad 260 receives an input of an instruction and is handled to control an operation of the electronic device 100. The dial keypad 260 can include a plurality of objects 261. By handling the plurality of objects 261, a user can input a numeral, a character, a special character, or the like.

Referring to FIG. 2C, if the user selects the search list screen 250 in the touch screen 190 by an input means of a user finger (F), a touch pen or the like, user information displayed in the search list screen 250 can be input to the input display region 240. As the user information, a user's phone number 243 can be input and illustrated in the input display region 240, but this does not intend to limit the scope and spirit of the disclosure. According to various exemplary embodiments, at least one or more of the user's phone number 243, a user name, a user's e-mail address, and a user's photo can be input to the input display region 240. Also, it can be appreciated that a numeral displayed in an object list icon 254 of the search list screen 250 is changed from existing ‘5’ to ‘1’. That is, it can be understood that the electronic device 100 has selected a specific object.

According to one exemplary embodiment, this state, i.e., a state of completing a user search through the IME 260 or a state of selecting the search list screen 250 and completing the search can be defined as a “search completion mode”. A state up to before completing the search can be defined as a “search mode”.

According to one exemplary embodiment, if the electronic device 100 enters the search completion mode, the existing dial keypad 260 displayed on the touch screen 190 can be changed into a user contents region 280. The user contents region 280 can arrange a plurality of objects 281, 282, 283, 284, and 285 at predetermined intervals or in a specific region. The objects 281, 282, 283, 284, and 285 can be set to change in location or region by a user. The objects 281, 282, 283, 284, and 285 can further include shortcut icons executable by the user.

According to various exemplary embodiments, the user contents region 280 can include event contents 281 displaying birthday or event information (for example, D-day, etc.) of a selected user, schedule contents 282 displaying a schedule with the selected user, message contents 284 displaying the latest message information exchanging with the selected user, and the like. The user contents region 280 can arrange SNS contents 285 displaying the latest conversations of an SNS application with the selected user by user's setting, photo contents 283 displaying a photo that the selected user tags to the SNS application, or the like. The user contents region 280 can be constructed focusing on a favorite member or a frequently contacting user.

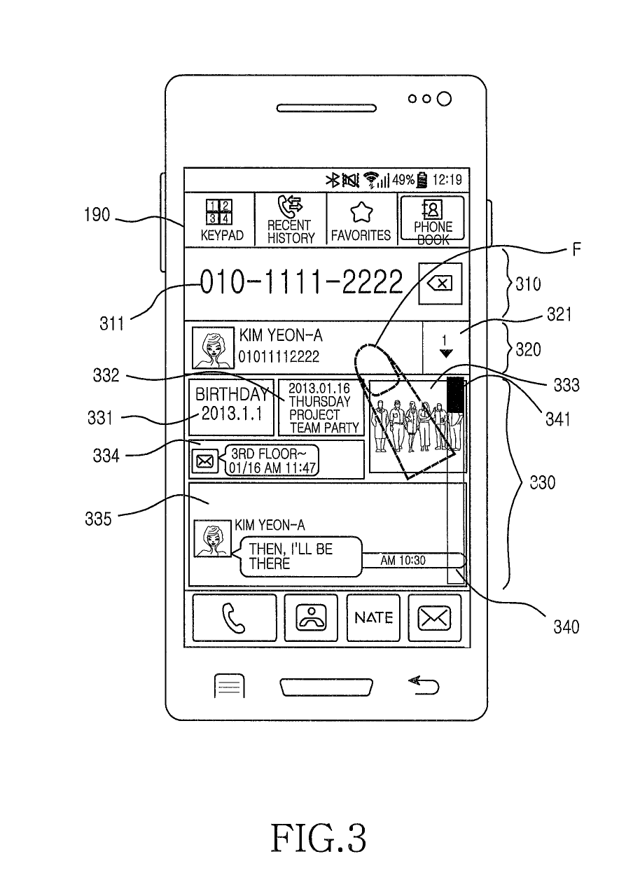

FIG. 3 illustrates a screen configuration where a search result is shown in an electronic device 100 according to one exemplary embodiment of the disclosure.

Referring to FIG. 3, if a user selects a search list screen 320 in the touch screen 190 by an input means of a user finger (F), a touch pen or the like, user information displayed in the search list screen 320 can be input to an input display region 310. As the user information, a user's phone number 311 can be input and illustrated in the input display region 310, but this does not intend to limit the scope and spirit of the disclosure. According to various exemplary embodiments, at least one or more of the user's phone number 311, a user name, a user's e-mail address, and a user's photo can be input to the input display region 310. Also, it can be appreciated that a numeral displayed in an object list icon 321 of the search list screen 320 is changed from existing ‘5’ to ‘1’. That is, it can be understood that the electronic device 100 has selected a specific object.

According to one embodiment, this state, i.e., a state of completing a user search through the IME 260 or a state of selecting the search list screen 320 and completing the search can be defined as a “search completion mode”. A state up to before completing the search can be defined as a “search mode”.

According to one embodiment, if the electronic device 100 is in the search completion state, the existing dial keypad 260 displayed on the touch screen 190 can be changed into a user contents region 330. The user contents region 330 can arrange a plurality of objects 331, 332, 333, 334, and 335 at predetermined intervals or in a specific region. The objects 331, 332, 333, 334, and 335 can be set to change in location or region by a user. The objects 331, 332, 333, 334, and 335 can further include shortcut icons executable by the user.

According to various embodiments, the user contents region 330 can include event contents 331 displaying birthday or event information (for example, D-day, etc.) of a selected user, schedule contents 332 displaying a schedule with the selected user, message contents 334 displaying the latest message information exchanging with the selected user, and the like. The user contents region 330 can arrange SNS contents 335 displaying the latest conversations of an SNS application with the selected user by user's setting, photo contents 333 displaying a photo that the selected user tags to the SNS application, or the like.

According to various embodiments, the user contents region 330 can further arrange a scroll bar 340 of a bar shape in a specific location. The scroll bar 340 can efficiently utilize the restricted user contents region 330. For example, when a user cannot see the entire contents because the user contents region 330 includes excessive contents, he/she can scroll pages constructing the user contents region 330 the way that he/she drags a slider 341. The slider 341 can move upward or downward according to drag direction, and the slider 341 can be implemented to move in left direction or right direction. The size of the slider 341 within the scroll bar 340 can be adjusted according to contents (or pages) included in the user contents region 330. The length of the slider 341 can represent any one page among several pages of the user contents region 330. It is obvious that the length of the slider 341 decreases as contents (or pages) are more included in the user contents region 330.

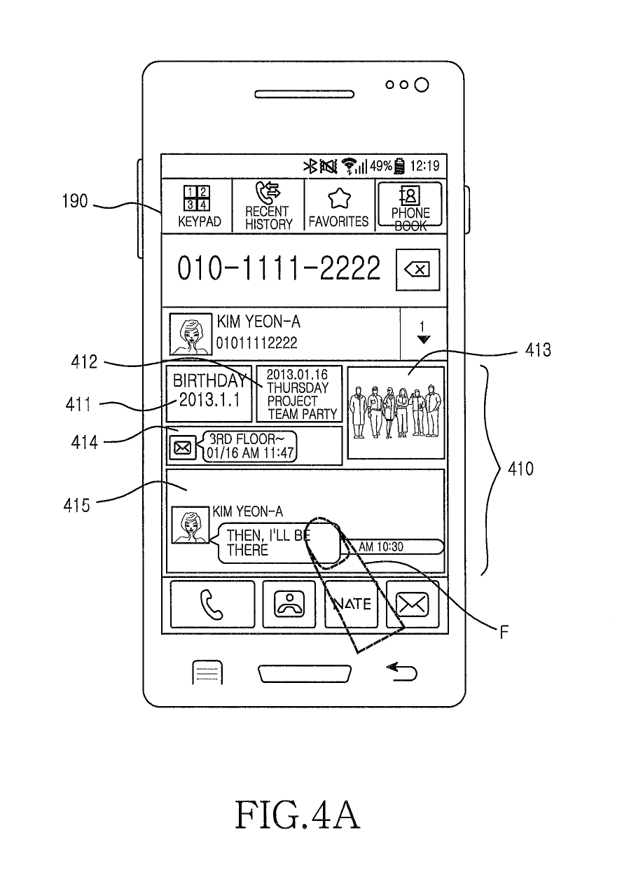

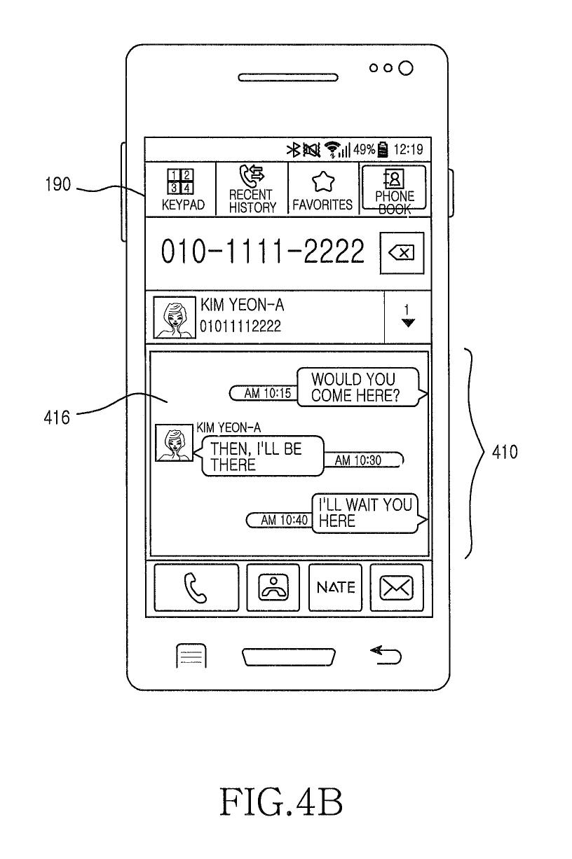

FIGS. 4A and 4B are diagrams illustrating an operation of executing an application in a search completion state according to various exemplary embodiments of the disclosure.

According to one embodiment, if the electronic device 100 is in the search completion state, the existing dial keypad 260 displayed on the touch screen 190 can be changed into a user contents region 410. The user contents region 410 can arrange a plurality of objects 411, 412, 413, 414, and 415 at predetermined intervals or in a specific region. The objects 411, 412, 413, 414, and 415 can be set to change in location or region by a user. The objects 411, 412, 413, 414, and 415 can further include shortcut icons executable by the user.

According to various embodiments, the user contents region 410 can include event contents 411 displaying birthday or event information (for example, D-day, etc.) of a selected user, schedule contents 412 displaying a schedule with the selected user, message contents 414 displaying the latest message information exchanging with the selected user, and the like. The user contents region 410 can arrange SNS contents 415 displaying the latest conversations of an SNS application with the selected user by user's setting, photo contents 413 displaying a photo that the selected user tags to the SNS application, or the like.

According to various embodiments, the electronic device 100 can further display information about a specific content 415 displayed on the touch screen 190. If the user touches the content 415 by a user finger (F) or a touch pen, the electronic device 100 can provide a detail view 416 for one content 415. The detail view 416 can be varied in size and arrangement according to the characteristic of the content 415. If the touched contents are SNS contents 415, the detail view 416 can further show the latest conversations. Undoubtedly, even when the touched contents are other contents 411, 412, 413, and 414, the detail view 416 can show more detailed information than existing information.

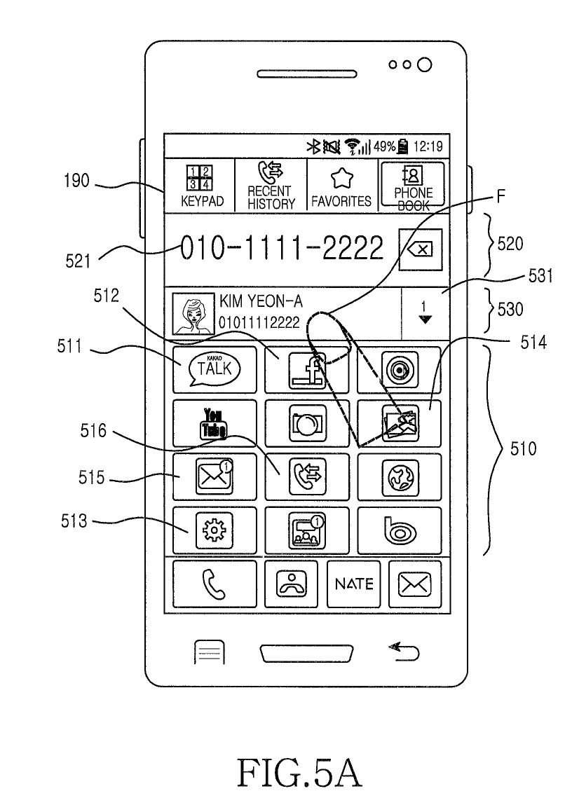

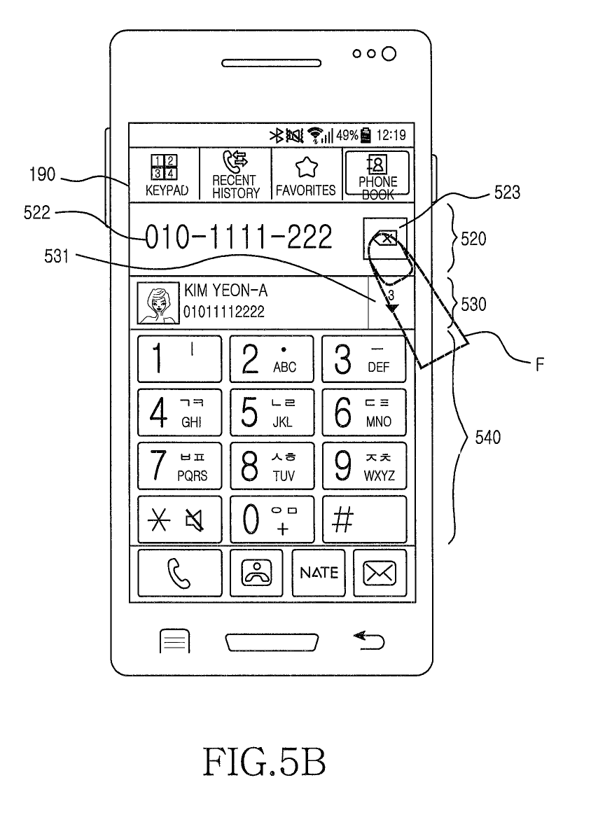

FIGS. 5A and 5B illustrate an operation of restoring to a search mode in a search completion state according to various exemplary embodiments of the disclosure.

Referring to FIG. 5A, if a user selects a search list screen 530 in the touch screen 190 by an input means of a user finger (F), a touch pen or the like, user information displayed in the search list screen 530 can be input to an input display region 520. As illustrated in FIG. 5A, as the user information, a user's phone number 521 can be input and illustrated in the input display region 520, but this does not intend to limit the scope and spirit of the disclosure. According to various exemplary embodiments, at least one or more of the user's phone number 521, a user name, a user's e-mail address, a user's photo, and a user's location or birthday can be input to the input display region 520. Also, it can be appreciated that a numeral displayed in an object list icon 531 of the search list screen 530 is changed from existing ‘5’ to ‘1’. That is, it can be understood that the electronic device 100 has selected a specific object.

According to one embodiment, this state, i.e., a state of completing a user search through the IME 260 or a state of selecting the search list screen 530 and completing the search can be defined as a “search completion mode”. A state up to before completing the search can be defined as a “search mode”.

If the electronic device 100 is in the search completion state, the existing dial keypad 260 displayed on the touch screen 190 can be changed into an icon housing region 510. The icon housing region 510 can arrange a plurality of objects 511, 512, 513, 514, 515, and 516 at predetermined intervals or in a specific region. The objects 511, 512, 513, 514, 515, and 516 can be set to change in location or region by a user. The objects 511, 512, 513, 514, 515, and 516 can further include shortcut icons executable by the user.

According to various embodiments, the icon housing region 510 can include a message entry icon 515 for message transmission/reception with a selected user, a gallery entry icon 514 for viewing a photo of the selected user, a configuration entry icon 513 for a configuration function for the selected user, a call history entry icon 516 for viewing a call history with the selected user, and the like. The icon housing region 510 can further arrange SNS application entry icons 511 and 512 for SNS application entry enabling communication with the selected user by user's setting, and the like. The message entry icon 515 of the icon housing region 510 can provide a notification of displaying the number of unread messages among messages transmitted from the selected user. A form of the notification can support a numeral, an image, a text, an animation, and the like.

Referring to FIG. 5B, if a backspace key 523 is selected by an input means such as a user finger (F), a touch pen or the like in an input display region 520, the electronic device 100 can delete a portion of a keyword 522 displayed in the input display region 520. The keyword 522 is input and displayed in a phone number form in the input display region 520, but this does not intend to limit the scope and spirit of the disclosure. The keyword 522 can include a phone number, an e-mail address, an initial sound, an initial, and the like.

According to one exemplary embodiment, if a portion of the keyword 522 displayed in the input display region 520 is deleted, the existing icon housing region 510 can be changed into a dial keypad 540. This state can be called a search mode. If the electronic device 100 enters the search mode, the electronic device 100 can more input or more delete the existing keyword 522 through the dial keypad 540. Also, it can be appreciated that a numeral displayed in an object list icon 531 of the search list screen 530 is changed from existing ‘1’ to ‘3’. In this case, it can be appreciated that the electronic device 100 has searched three objects corresponding to the keyword 522. If the object list icon 531 is executed, user information about the three objects corresponding to the input keyword 522 can be displayed. The user information can include a user name, a user's photo, a user's phone number, a user's e-mail address, a user's location, application information, and the like.

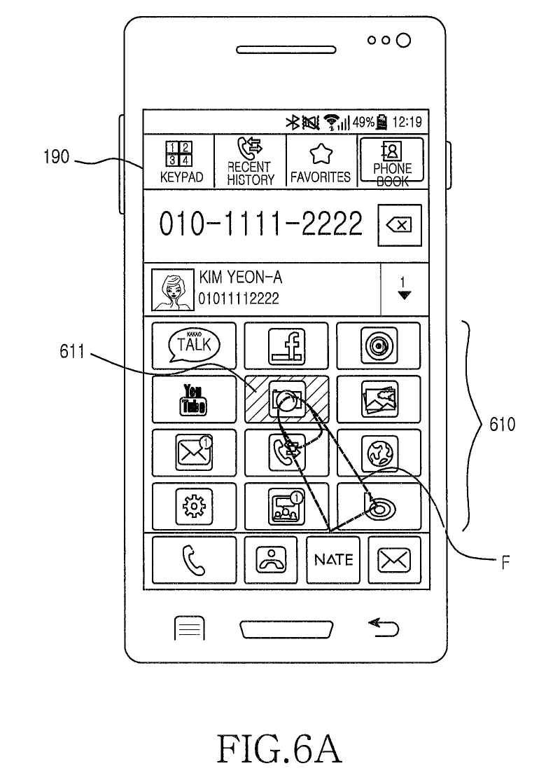

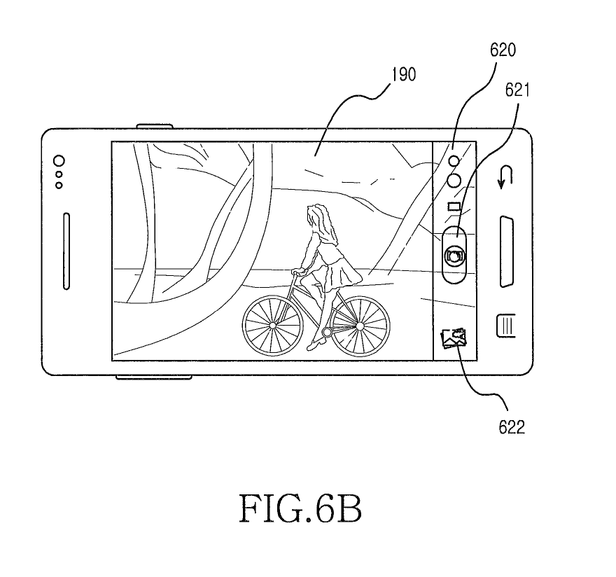

FIGS. 6A and 6B illustrate an operation of executing an application on a search result according to embodiments of the disclosure.

Referring to FIGS. 6A and 6B, the electronic device 100 can execute an icon 611 included in an icon housing space 610 of the touch screen 190 in the search completion state. The icon 611 enables the electronic device 100 to enter an application performing an operation related to a selected user. According to one exemplary embodiment, if a user touches a camera entry icon 611 included in the icon housing space 610 by an input means such as a user finger (F), a touch pen, or the like, the electronic device 100 can get to execute a camera application. That is, the electronic device 100 gets to enter a camera mode. In this case, the electronic device 100 can display on the touch screen 190 an image acquired through the camera device 130. Also, the electronic device 100 can create a photo-only folder having a name of the selected user as a name of the folder. After that, the electronic device 100 can store a taken image in the photo-only folder or can transmit the taken image to the selected user through wired, wireless communication.

According to one embodiment, if the electronic device 100 enters a camera mode, a camera function window 620 can be arranged in a predetermined region of the touch screen 190. The camera function window 620 can arrange a plurality of objects 621 and 622 at predetermined intervals or in a specific region. The objects 621 and 622 can be set to change in location or region by a user. The objects 621 and 622 can further include shortcut icons executable by the user.

According to various exemplary embodiments, the camera function window 620 can include a capture button 621 capable of taking an image currently displayed on the touch screen 190, a gallery entry icon 622 entering a gallery application, and the like. If operating the capture button 621, the electronic device 100 can store a taken image in the photo-only folder of the selected user or can transmit the taken image to the selected user through wired, wireless communication. In a case of the wireless communication, the electronic device 100 can be designed to operate through at least one of an EDGE network, a CDMA network, a W-CDMA network, an LTE network, an OFDMA network, a Wi-Fi network, a WiMAX network, and a Bluetooth network.

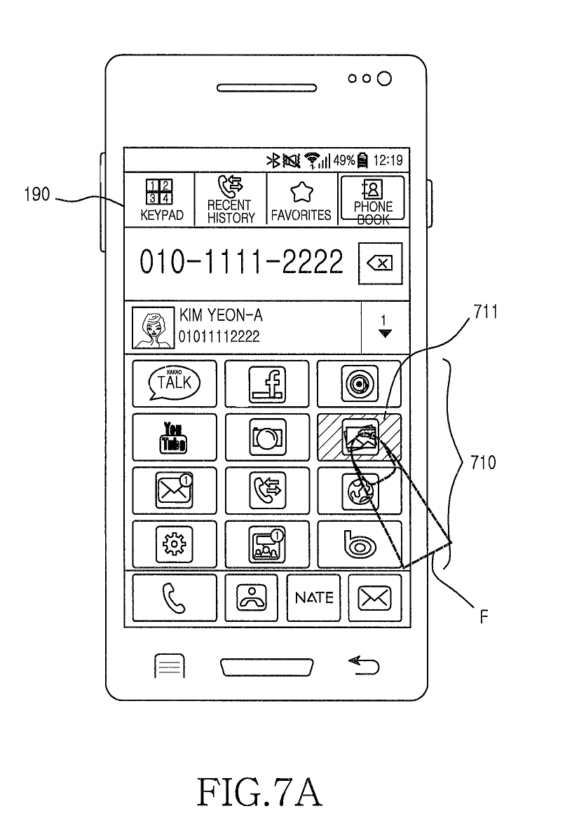

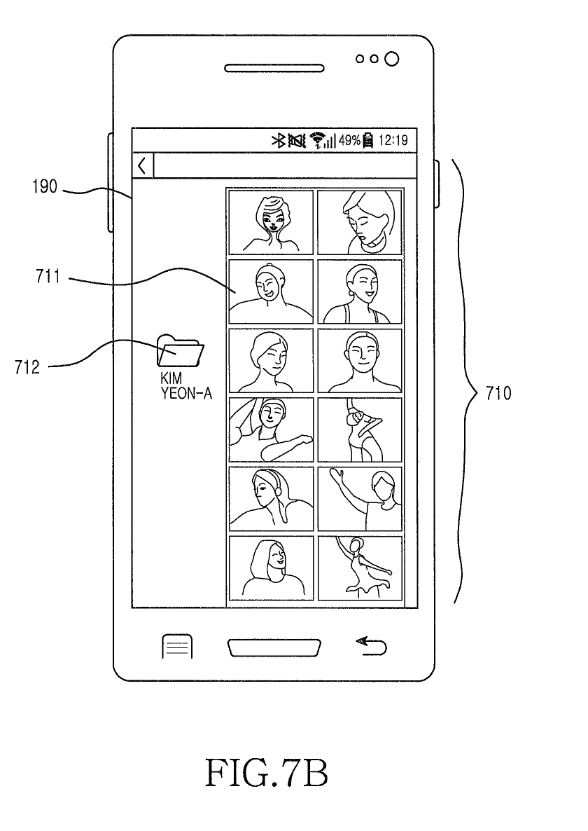

FIGS. 7A and 7B illustrate an operation of executing an application on a search result according to embodiments of the disclosure.

Referring to FIGS. 7A and 7B, the electronic device 100 can execute an icon 711 included in an icon housing space 710 of the touch screen 190 in the search completion state. The icon 711 enables the electronic device 100 to enter an application performing an operation related to a selected user. According to one exemplary embodiment, if a user touches a gallery entry icon 711 included in the icon housing space 710 by an input means such as a user finger (F), a touch pen, or the like, the electronic device 100 can get to execute a gallery application. In this case, the electronic device 100 can create a photo-only folder 712 having a name of the selected user as a name of the folder. The photo-only folder 712 can align and arrange images 711 of the selected user stored in the electronic device 100, The electronic device 100 can analyze or recognize a face of the selected user stored in a memory and determine the images 711 of the selected user.

According to embodiments, if the electronic device 100 enters a gallery mode, the electronic device 100 can arrange the images 711 of the selected user in a predetermined region of the touch screen 190. This arrangement can be changed by user setting and the user can set the size and number of images 711 displayed on the touch screen 190. If the user selects these images 711 by an input means such as a user finger (F), a touch pen and the like, the electronic device 100 can transmit the selected images 711 to the selected user through wired, wireless communication. In a case of the wireless communication, the electronic device 100 can be designed to operate through at least one of an EDGE network, a CDMA network, a W-CDMA network, an LTE network, an OFDMA network, a Wi-Fi network, a WiMAX network, and a Bluetooth network.

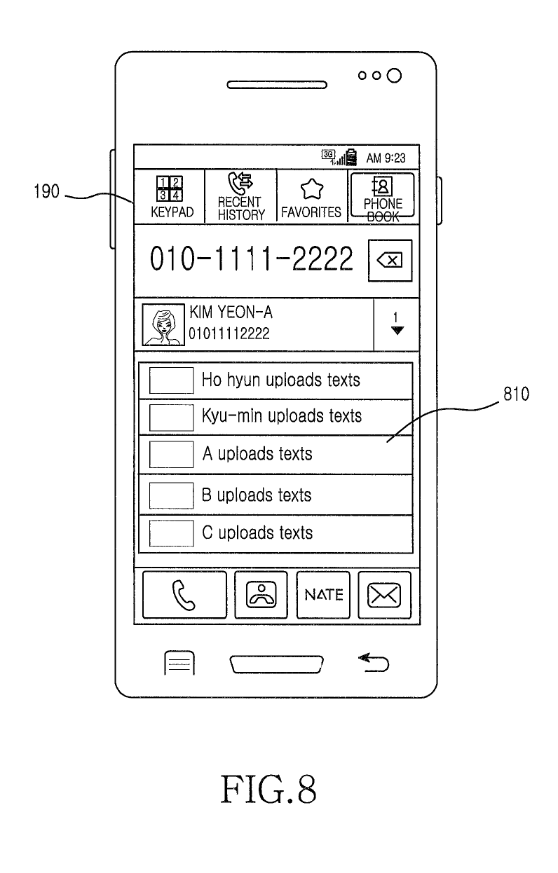

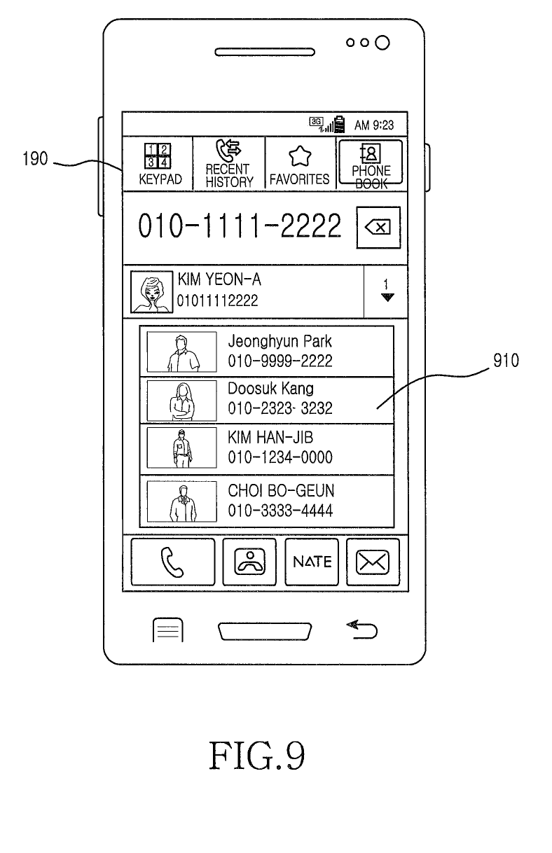

FIG. 8 and FIG. 9 illustrate a screen configuration of a search result according to various exemplary embodiments of the disclosure.

Referring to FIGS. 8 and 9, the electronic device 100 can display information related to a selected user in the search completion state. This information can be collected from an SNS application.

According to one embodiment, if the electronic device 100 enters a search completion mode, the electronic device 100 can display the latest update content or upload content of the selected user in the SNS application. A user can know the latest recent state of the selected user.

According to various embodiments, if the electronic device 100 enters the search completion mode, the electronic device 100 can display simple information such as a phone number, a birthday, a resident area, and the like related to the selected user from the SNS application.

Prior to describing exemplary embodiments below, many concrete descriptions can be omitted because the latter description is similar with the former description. This should be understood attentively.

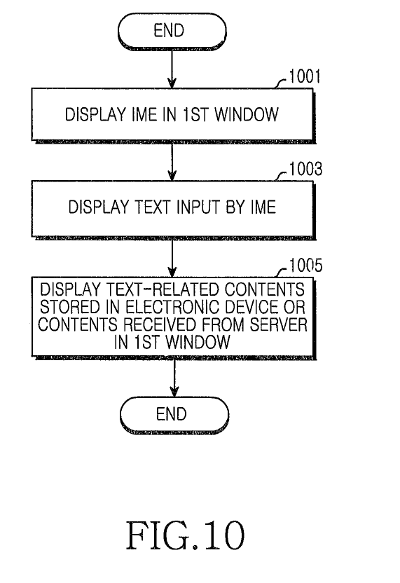

FIG. 10 is a flowchart illustrating an operation method of an electronic device 100 according to various embodiments of the disclosure.

Referring to FIG. 10, in operation 1001, the electronic device 100 can display an IME in a 1st window. According to various exemplary embodiments, the IME can be a virtual keypad. This virtual keypad can be a dial keypad 260 as illustrated in FIG. 2B. The 1st window can be a dialing screen for call, But, the 1st window is not limited to this, and the 1st window can be various screens such as an application execution screen, a basic setting screen or the like. Next, in operation 1003, the electronic device 100 can display a text that is input to the IME. According to various exemplary embodiments, the text can be some or all of at least one of a name, a phone number, an initial sound, an e-mail address, and an initial. This text can be displayed in at least a portion of the 1st window. For example, the input text can be mapped with data stored in a phone number of the electronic device 100. Next, in operation 1005, the electronic device 100 can display text-related contents stored in the electronic device 100 or contents received from a server, in the 1st window. According to various exemplary embodiments, the contents can be substitutively displayed in a region of at least a portion of the 1st window. These contents can include user information of a user corresponding to the input text. The user information can include at least one of a name, a phone number, a photo, an address, a location and application information. Also, the application information can include an application entry icon of at least one of gallery, camera, SNS, message, schedule, e-mail, and user based applications related to the user. But, this does not intend to limit the scope and spirit of the disclosure, and the application information can include various application entry icons. An instruction set for this each operation can be stored as one or more modules in the aforementioned memory. In this case, the module stored in the memory can be executed by one or more processors 112.

Various embodiments of an operation procedure of a process that an electronic device performs in a search mode or a search completion mode are described below, but this does not intend to limit the scope or the spirit of the disclosure. For example, it should be noted that the electronic device can be embodied even in a state of executing various applications or in a basic setting screen state.

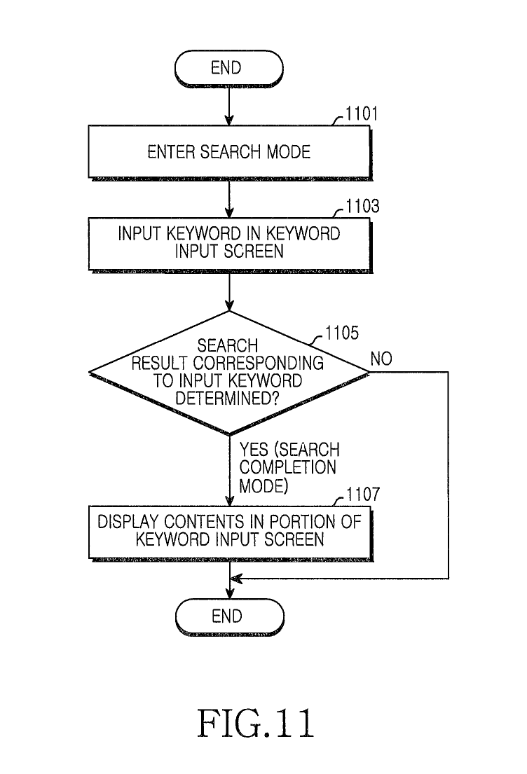

FIG. 11 is a flowchart illustrating an operation method of an electronic device 100 according to various embodiments of the disclosure.

Referring to FIG. 11, in operation 1101, the electronic device 100 can enter a search mode. As illustrated in FIG. 2B, the electronic device 100 can enter a search mode being a state of inputting the keyword 241 to the input display region 240 through the dial keypad 260 in a dialing screen in which the dial keypad 260 is displayed.

Next, in operation 1003, the electronic device 100 can input a keyword in a keyword input screen. As illustrated in FIG. 2B, a user can input the keyword 241 by touch inputting the dial keypad 260. The keyword 241 can include, for example, a phone number related to user information stored in a phone book, an initial sound, an e-mail address, an initial and the like.

After that, in operation 1105, the electronic device 100 can determine the search result corresponding to the input keyword. As illustrated in FIG. 2C, if a user selects a search list screen 250 in the touch screen 190 by an input means of a user finger (F), a touch pen or the like, user information displayed in the search list screen 250 can be input to an input display region 240. As illustrated in FIG. 2C, as the user information, a user's phone number 243 is input and illustrated in the input display region 240, but this does not intend to limit the scope and spirit of the disclosure. According to various exemplary embodiments, at least one or more of the user's phone number 243, a user name, a user's e-mail address, and a user's photo can be input to the input display region 240.

Next, in operation 1107, the electronic device 100 can display contents in a portion of a keyword input screen. As illustrated in FIG. 2C, the contents can include event contents 281 displaying birthday or event information of a selected user, schedule contents 282 displaying a schedule with the selected user, message contents 284 displaying the latest message information exchanging with the selected user, and the like. Also, a contents region 280 can arrange SNS contents 285 displaying the latest conversations of an SNS application with the selected user by user's setting, photo contents 283 displaying a photo that the selected user tags to the SNS application, or the like.

An instruction set for this each operation can be stored as one or more modules in the aforementioned memory. In this case, the module stored in the memory can be executed by one or more processors 112.

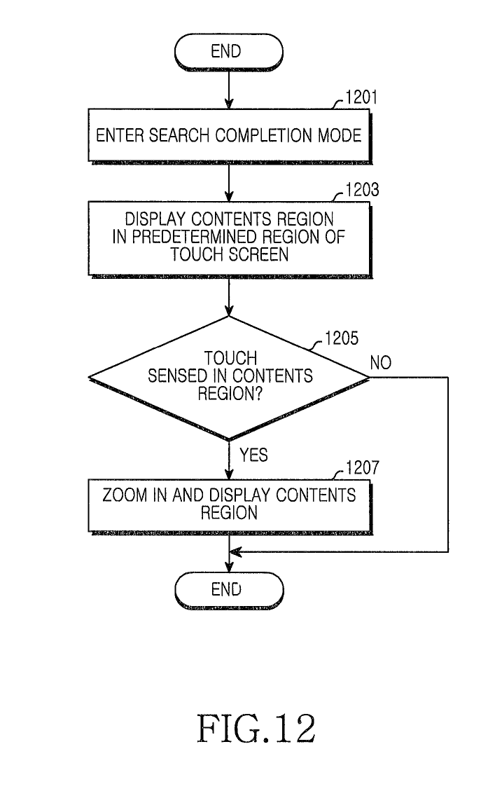

FIG. 12 is a flowchart illustrating an operation method of an electronic device 100 according to various exemplary embodiments of the disclosure.

Referring to FIG. 12, in operation 1201, the electronic device 100 can enter a search completion mode. As illustrated in FIG. 2C, if a user selects a search list screen 250 in the touch screen 190 by an input means of a user finger (F), a touch pen or the like, user information displayed in the search list screen 250 can be input to an input display region 240. As illustrated in FIG. 2C, as the user information, a user's phone number 243 is input and illustrated in the input display region 240, but this does not intend to limit the scope and spirit of the disclosure. The user information can include at least one or more of the user's phone number 243, a user name, an initial sound, a user's e-mail address, and a user's photo that are input to the input display region 240. This state, that is, a state in which the user selects the search list screen 250 and the user information is input to the input display region 240 can be defined as a “search completion mode”.

Next, in operation 1203, the electronic device 100 can display a contents region in a predetermined region of the touch screen 190. As illustrated in FIG. 2C, the user contents region 280 can include event contents 281 displaying birthday or event information (for example, D-day, etc.) of a selected user, schedule contents 282 displaying a schedule with the selected user, message contents 284 displaying the latest message information exchanging with the selected user, and the like. The user contents region 280 can arrange SNS contents 285 displaying the latest conversations of an SNS application with the selected user by user's setting, photo contents 283 displaying a photo that the selected user tags to the SNS application, or the like.

After that, in operation 1205, the electronic device 100 can sense a touch in the contents region. If the electronic device 100 senses a touch to the user contents region 410 as illustrated in FIG. 4A, next, in operation 1207, the electronic device 100 can zoom in and display the contents region. As illustrated in FIG. 4B, the electronic device 100 can further display information about a specific content 415 displayed on the touch screen 190. If the user touches the content 415 by a user finger (F) or a touch pen as illustrated in FIG. 4A, the electronic device 100 can provide a detail view 416 for one content 415. The detail view 416 can be varied in size and arrangement according to the characteristic of the content 415. According to one exemplary embodiment, if the touched contents are SNS contents 415, the detail view 416 can further show the latest conversations. Undoubtedly, even when the touched contents are other contents 411, 412, 413, and 414, the detail view 416 can show more detailed information than existing information.

An instruction set for this each operation can be stored as one or more modules in the aforementioned memory. In this case, the module stored in the memory can be executed by one or more processors 112.

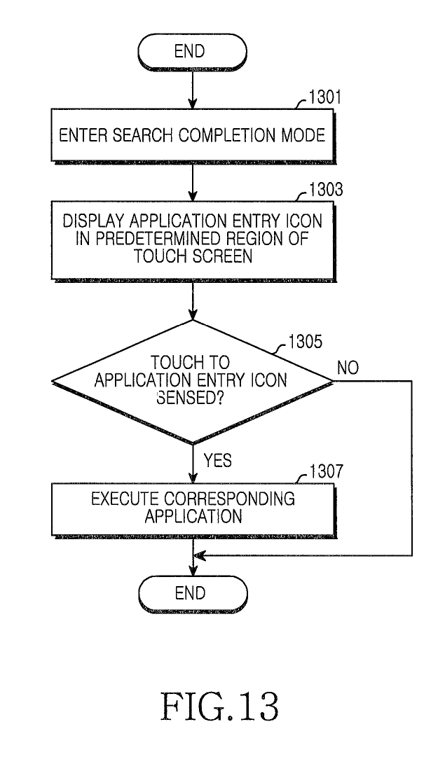

FIG. 13 is a flowchart illustrating an operation method of an electronic device 100 according to various exemplary embodiments of the disclosure.

Referring to FIG. 13, in operation 1301, the electronic device 100 can enter a search completion mode. As illustrated in FIG. 2C, if a user selects a search list screen 250 in the touch screen 190 by an input means of a user finger (F), a touch pen or the like, user information displayed in the search list screen 250 can be input to an input display region 240. As illustrated in FIG. 2C, as the user information, a user's phone number 243 is input and illustrated in the input display region 240, but this does not intend to limit the scope and spirit of the disclosure. The user information can include at least one or more of the user's phone number 243, a user name, an initial sound, a user's e-mail address, and a user's photo that are input to the input display region 240. This state, that is, a state in which the user selects the search list screen 250 and the user information is input to the input display region 240 can be defined as a “search completion mode”.

Next, in operation 1303, the electronic device 100 can display an application entry icon in a predetermined region. As illustrated in FIG. 5A, the icon housing region 510 can include a message entry icon 515 for message transmission/reception with a selected user, a gallery entry icon 514 for viewing a photo of the selected user, a configuration entry icon 513 for a configuration function for the selected user, a call history entry icon 516 for viewing a call history with the selected user, and the like. Also, the icon housing region 510 can further arrange SNS application entry icons 511 and 512 for SNS application entry enabling communication with the selected user by user's setting, and the like. The message entry icon 515 of the icon housing region 510 can display the number of unread messages among messages transmitted from the selected user.

After that, in operation 1305, the electronic device 100 can sense a touch to the application entry icon. If the electronic device 1305 senses a touch to the application entry icon, next, in operation 1307, the electronic device 100 can execute a corresponding application. For example, if a user touches a camera entry icon 611 among various icons included in the icon housing space 610 by an input means such as a user finger (F), a touch pen, or the like as illustrated in FIG. 6A, the electronic device 100 can get to execute a camera application. That is, the electronic device 100 gets to enter a camera mode. In this case, the electronic device 100 can display on the touch screen 190 an image acquired through the camera device 130. Also, the electronic device 100 can create a photo-only folder having a name of the selected user as a name of the folder. After that, the electronic device 100 can store a taken image in the photo-only folder or can transmit the taken image to the selected user through wired, wireless communication.

An instruction set for this each operation can be stored as one or more modules in the aforementioned memory. In this case, the module stored in the memory can be executed by one or more processors 112.

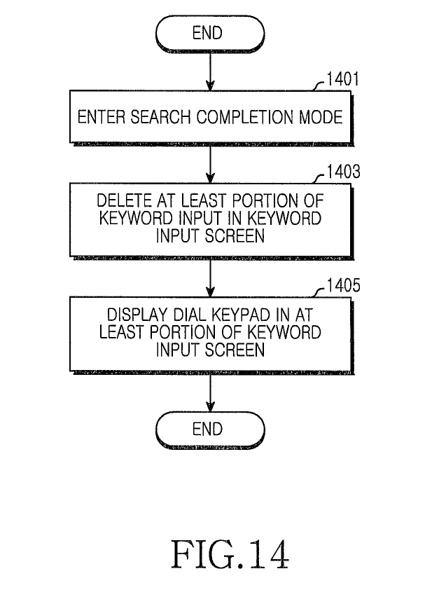

FIG. 14 is a flowchart illustrating an operation method of an electronic device 100 according to various exemplary embodiments of the disclosure.

Referring to FIG. 14, in operation 1401, the electronic device 100 can enter a search completion mode. As illustrated in FIG. 5A, if a user selects a search list screen 530 in the touch screen 190 by an input means of a user finger (F), a touch pen or the like, user information displayed in the search list screen 530 can be input to an input display region 520. As illustrated in FIG. 5A, as the user information, a user's phone number 521 is input and illustrated in the input display region 520, but this does not intend to limit the scope and spirit of the disclosure. The user information can include at least one or more of the user's phone number 521, a user name, an initial sound, a user's e-mail address, and a user's photo that are input to the input display region 520. This state, that is, a state in which the user selects the search list screen 530 and the user information is input to the input display region 520 can be defined as a “search completion mode”.

Next, in operation 1403, the electronic device 100 can delete at least a portion of a keyword that is input in a keyword input screen. As illustrated in FIG. 5B, if a backspace key 523 is selected by the input means such as the user finger (F), the touch pen or the like in the input display region 520, the electronic device 100 can delete a portion of a keyword 522 displayed in the input display region 520. Here, the keyword 522 is input and displayed in a phone number form in the input display region 520, but this does not intend to limit the scope and spirit of the disclosure. The keyword 522 can include a phone number, an e-mail address, an initial sound, an initial, and the like.

After that, in operation 1405, the electronic device 100 can display a dial keypad in at least a portion of the keyword input screen. As illustrated in FIG. 5B, if a portion of the keyword 522 displayed in the input display region 520 is deleted, the existing icon housing region 510 can be changed into a dial keypad 540. This state can be called a search mode. If the electronic device 100 enters the search mode, the electronic device 100 can more input or more delete the existing keyword 522 through the dial keypad 540.

An instruction set for this each operation can be stored as one or more modules in the aforementioned memory. In this case, the module stored in the memory can be executed by one or more processors 112.

Various embodiments of the disclosure illustrate and describe a process of inputting a keyword through a dial keypad in an electronic device, and contents corresponding to the keyword, but they do not intend to limit the scope and spirit of the disclosure. For example, the electronic device can display an IME on various screens, and can display contents related to a text input to the IME on the various screens.

According to various exemplary embodiments of the disclosure, respective modules can be configured by software, firmware, hardware or a combination thereof. Also, some or all modules are constructed in one entity, and can identically perform a function of each module. According to various exemplary embodiments of the disclosure, respective operations can be executed sequentially, repeatedly, or in parallel. Also, some operations can be omitted or other operations can be added and executed. For example, the respective operations can be executed by corresponding modules described in the disclosure.

Methods according to embodiments disclosed in claims and/or specification of the disclosure can be implemented in a form of hardware, software, or a combination of hardware and software.

In a case of implementing in the software form, a computer readable storage medium storing one or more programs (i.e., software modules) can be provided. One or more programs stored in the computer readable storage medium are executable by one or more processors within an electronic device. The one or more programs can include instructions for enabling the electronic device to execute the methods according to the exemplary embodiments disclosed in the claims and/or specification of the disclosure.

These programs (i.e., software modules or software) can be stored in a Random Access Memory (RAM), a nonvolatile memory including a flash memory, a Read Only Memory (ROM), an Electrically Erasable Programmable ROM (EEPROM), a magnetic disk storage device, a Compact Disk ROM (CD-ROM), a Digital Versatile Disk (DVD) or an optical storage device of other form, and a magnetic cassette. Or, the programs can be stored in a memory configured by a combination of some or all of them. Also, each configuration memory can be included in plurality.

Also, the programs can be stored in an attachable storage device accessible to the electronic device through a communication network such as the Internet, an intranet, a Local Area Network (LAN), a Wireless LAN (WLAN) and a Storage Area Network (SAN) or a communication network configured by a combination of them. This storage device can access the electronic device through an external port.

Also, a separate storage device on a communication network may access a portable electronic device.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method in an electronic device, the method comprising the operations of:
displaying an Input Method Editor (IME) on a window on the electronic device;
receiving data that is entered through the IME;
searching for at least one content including a text message, the content being related to the text; and
displaying a search result on the window.

2. The method of claim 1, wherein the IME is a virtual keypad.

3. The method of claim 1, wherein the window is a dialing screen for a call.

4. The method of claim 1, wherein, if at least a portion of the data is deleted, the IME is re-displayed in the window.

5. The method of claim 1, wherein the data is some or all of at least one of a name, a phone number, an initial sound, an electronic-mail (e-mail) address, and an initial.

6. The method of claim 5, wherein the at least one content comprises user information of a user corresponding to the text.

7. The method of claim 6, wherein the user information comprises at least one of the name, the phone number, a photo, a birthday, an address, a location, and application information.

8. The method of claim 7, wherein the application information comprises an application entry icon of at least one of gallery, camera, Social Network Service (SNS), message, schedule, e-mail, and user based applications related to the user.

9. The method of claim 1, wherein at least one content is substitutively displayed in a region of at least a portion of the window.

10. An electronic device comprising:
a touch screen configured to receive a touch input; and
at least one processor coupled with the touch screen,
wherein the processor is configured to
cause the touch screen to display an Input Method Editor (IME) in a window,
search for at least one content including a text message, the content being related to the text; and
display a search result on the window.

11. The electronic device of claim 10, wherein the IME is a virtual keypad.

12. The electronic device of claim 10, wherein the window is a dialing screen for a call.

13. The electronic device of claim 10, wherein, if deleting at least a portion of the input text, the processor controls to re-display the IME in the window.

14. The electronic device of claim 10, wherein the text is some or all of at least one of a name, a phone number, an initial sound, an electronic-mail (e-mail) address, and an initial.

15. The electronic device of claim 14, wherein at least one content comprises user information of a user corresponding to the text.

16. The electronic device of claim 15, wherein the user information comprises at least one of the name, the phone number, a photo, a birthday, an address, a location, and application information.

17. The electronic device of claim 16, wherein the application information comprises an application entry icon of at least one of gallery, camera, Social Network Service (SNS), message, schedule, e-mail, and user based applications related to the user.

18. The electronic device of claim 10, wherein the processor is configure to control the touch screen to in a region of at least a portion of the window the contents stored in the electronic device or the contents received from the server.
